(19) United States
(12) Patent Application Publication
(10) Pub. No.: US 2008/0153650 A1
(43) Pub. Date: Jun. 26, 2008

(54) TRANSMISSION WITH RESISTANCE TORQUE CONTROL

(75) Inventors: James Y. Gleasman, Rochester, NY (US); Keith E. Gleasman, Fairport, NY (US); Donald Gabel, Rochester, NY (US)

Correspondence Address: MORTON A. POLSTER;BROWN & MICHAELS, P.C., 400 M & T BANK BUILDING, 118 N. TIOGA STREET, ITHACA, NY, 14850, US

(73) Assignee: TORVEC, INC., Rochester, NY (US)

(21) Appl. No.: 11/960,931

(22) Filed: Dec. 20, 2007

Related U.S. Application Data
(63) Continuation-in-part of application No. 11/615,532, filed on Dec. 22, 2006.

(51) Int. Cl. F16H 48/06

(52) U.S. Cl. 475/149

(57) ABSTRACT

In the basic embodiment, the transmission includes (a) a minimal-orbiter gear complex having only a control gear and an output gear interconnected by the gearing portions of at least one cluster gear supported by an orbiting web responsive to an input drive provided by a primary engine and (b) a single, infinitely-variable rotary control device providing resistance torque to counter engine torque to slow and stop the control gear of the orbital complex. The rotary control device, which may be a hydraulic jack or an electrically braked magnetic wheel, provides no propelling motion but rather only provides a resistive torque. In a preferred embodiment for automotive use, the engine torque is split at all times between two mechanical paths. One path drives the web of a minimal orbiter gear set, and the other drives the sun gear of a single, standard planetary gear set.

### REFERENCE TO RELATED APPLICATIONS

This is a Continuation-In-Part patent application of co-pending U.S. patent application Ser. No. 11/615,532, filed Dec. 22, 2006, entitled “TRANSMISSION WITH RESISTANCE TORQUE CONTROL”. The subject matter in this application is related to the subject matter in co-pending U.S. patent application Ser. No. 11/153,112, filed Jun. 15, 2005, entitled “ORBITAL TRANSMISSION WITH GEARED OVERDRIVE”. The aforementioned applications are hereby incorporated herein by reference.

### BACKGROUND OF THE INVENTION

1. Field of the Invention

The invention pertains to the field of automotive transmissions. More particularly, the invention pertains to an infinitely-variable automotive transmission with orbital gearing and resistance torque control.

2. Description of Related Art

Known conventional transmissions use the vehicle's engine as the primary control for making changes in vehicle speed.

The manual transmission uses a clutch to change the gear ratio, with the engine being completely disconnected from the transmission momentarily during each level of gear change and also with the engine being quickly revved up to fairly high rpm during each level change.

The standard automatic transmission uses a torque converter to avoid the complete disconnect of the engine between levels of gear ratio change, but the inefficiency of the torque converter causes considerable slippage between engine and transmission output, particularly during initial start-up and lower speeds, when as much as 50% of the engine torque may be lost. This type of transmission blends engine and transmission better than the manual transmission, but the engine still must be revved to high rpm during each level of multiple gear change. Also, even during engine idle when the vehicle is stationary, the automatic transmission creates a constant loss of efficiency through hydraulic losses occurring in the torque converter.

The conventional acceleration rates for engine rpm during the revving for each gearing level in both manual and automatic transmissions is often between 1000-2000 rpm/sec, and this rapid acceleration of the engine's internal parts (crankshaft, pistons, valve cams) can result in a 20-25% loss in efficiency.

There have been many different forms of automatic infinitely-variable transmissions (“IVT”), in which usable torque is supplied to the drive wheels of the automotive vehicle through a continuum of constantly variable speeds. The IVT is distinguished from the continuously-variable transmission (“CVT”), in which vehicle speed is continuously changed throughout successively-increasing speeds and torque output levels but, at start up, requires the assistance of a clutch or torque converter. However, until recently, no IVT or CVT has been developed that is capable of successfully handling a full range of torque and engine sizes from a very small vehicle through a large commercial truck. Torvec, Inc., the assignee of the present invention, has recently successfully tested an IVT that does not require the assistance of a clutch or torque converter and can be readily sized to cover this entire range of engine size and torque requirements. Also, this recently tested IVT was specifically designed for propelling not only large SUVs (sport utility vehicles) but also small trucks and school buses. One of the latest designs of the Torvec IVT is disclosed in U.S. Pat. No. 6,748,817, entitled “Transmission with Minimal Orbiter”.

Torvec IVTs have been progressively improved during an extensive period of product testing, and a current design produces continuous changes of torque and speed from start-up through an overdrive ratio without any intermediate discontinuities while using engine acceleration rates of no more than 90-100 rpm/sec. These remarkable results are achieved with an apparatus that is significantly smaller and lighter than presently-available conventional automotive transmissions.

The earlier Torvec IVT designs combined a variable hydraulic pump and a hydraulic motor with a gear orbiter to form an infinitely variable transmission so that as the speed of the hydraulic motor increases the rotation of the gear orbiter, the output shaft speed increases and the speed of the vehicle increases. This basic design was recently significantly modified to operate in an unconventional manner. Namely, while the engine input was delivered to an input sun gear of the orbiting gear complex, the changes in output gear ratios were obtained by using the combined operation of the variable hydraulic pump and motor to slow the rotation of the web so that, as the rotation of the web in the direction of the engine was slowed, the transmission produced a continuously decreasing gear reduction, and, when the web was brought to a stop, the transmission provided an overdrive ratio of the engine input.

The recent Torvec transmissions just discussed increase transmission efficiency by using a hydraulic pump and motor combination, rather than the vehicle engine, as a primary control of vehicle speed, thereby avoiding the above-mentioned engine acceleration losses. However, even these recent Torvec transmission designs still lose some efficiency through the split torque path that delivers output torque through the hydraulic pump and motor.

Special attention is also called to another prior art apparatus, namely, the Torvec long-piston hydraulic machines disclosed in U.S. Pat. No. 6,983,680 and U.S. 2004/0168567, which are hereby incorporated herein by reference. This prior art is referred to in greater detail in the Detailed Description section below.

The invention disclosed herein is a further improvement of the successfully-tested earlier versions of the Torvec IVT just discussed above, and the hydraulic machine in two of the disclosed embodiments of the invention utilizes a variation of the hydraulic machine disclosed in U.S. Pat. No. 6,983,680 and U.S. 2004/0168567.

### SUMMARY OF THE INVENTION

A transmission of the present invention is a remarkably small structure that in two of the disclosed embodiments includes only a minimal-orbiter gear complex and a single rotary control device. The minimal orbiter includes only: a control gear and an output gear interconnected by the different gearing portions of at least one cluster gear supported by an orbiting web responsive to an input drive provided by a primary engine. The rotary control device may be any kind of apparatus that is capable of providing infinitely-variable resistance torque sufficient to match the torque of the primary engine to slow and stop the control gear of the orbital complex.

In a first embodiment, the rotary control device is a hydraulic jack machine having a drive shaft connected to an adjustable swash plate and having input and output ports connected through a very minimal fluid passage that is closed by a controlled pressure valve. [NOTE: The term “hydraulic jack” is used herein to denote a hydraulic transducer that provides no propelling motion whatsoever but rather is used for no other reason than to create a controlled resistive torque in the form of hydraulic pressure.] This single hydraulic jack machine generates resistance torque during vehicle acceleration but places negligible load on the vehicle's engine during start-up, engine idle, and vehicle cruising. Also, the operation of this single hydraulic machine omits the hydraulic pump that is conventionally used in hydro-mechanically-controlled transmissions. The invention increases efficiency by using the hydraulic jack only for slowing the operation of the gearing rather than driving it in the conventional manner.

In a second embodiment, the rotary control device is an electro-magnetic brake that generates a resistance torque to slow and stop the rotation of a magnetic wheel that is connected to the control gear. Again, this magnetic brake, like the hydraulic brake of the first embodiment, increases efficiency by slowing the operation of the gearing rather than driving it in the conventional manner.

In a third embodiment preferred for use in most vehicles (e.g., passenger cars, sports utility vehicles, and trucks), only a single conventional planetary gear complex using an outside ring gear is added to provide a feedback of torque that opposes the resistive torque created by the hydraulic jack machine to decrease the rate of change in the orbiter output gear ratio between a highest reduction and the predetermined overdrive of the input drive provided by the primary engine. That is, when the vehicle's engine is operated at speeds no greater than 750-1500 rpm, this planetary complex extends the period of infinitely-variable gear reduction until the vehicle reaches speeds of 25-48 mph.

In another embodiment of the present invention, a second hydraulic machine is included to create a hybrid drive. The vehicle's primary drive is provided by either a gas or diesel engine using the invention's just-described simplified hydraulic transmission. However, an accumulator assembly is added to the structure (a) to store the kinetic energy of the vehicle during coasting or braking in the form of pressurized hydraulic fluid and (b) to reuse that stored energy to assist in the acceleration or driving of the vehicle. The rotation of the vehicle's drive shaft during coasting and braking conditions is used as an input to a hydraulic machine, acting as a pump, to deliver hydraulic fluid from a reservoir to a pressurized tank. To assist in the acceleration of the vehicle, this same hydraulic machine, acting as a motor, is driven by the stored pressurized fluid to provide supplemental driving torque to the vehicle's drive shaft.

### BRIEF DESCRIPTION OF THE DRAWINGS

FIG. 1 is a schematic view of a first embodiment of the hydraulic jack version of the present invention, showing a cross section of the orbital gear complex.

FIG. 2 is a block diagram of the transmission in FIG. 1, showing in schematic form a cross section of the invention's hydraulic jack machine.

FIG. 3 is a schematic view of a preferred embodiment of the electro-magnetic brake version of the present invention, showing the orbital gear complex, magnetic wheel and coil in cross section and illustrating other components with block diagrams.

FIG. 4A is a perspective view of the orbital gear complex, magnetic wheel and coil portions of FIG. 3.

FIG. 4B shows the magnetic wheel of FIG. 4A with the coil removed.

FIG. 5 is a schematic view of a further embodiment of the present invention showing a supplemental single conventional planetary complex to provide a torque feedback, the relative size of the respective gears serving to represent only a general approximation of actual gear ratios.

FIG. 6 is a partially schematic view of a further embodiment of the present invention including accumulator apparatus appropriate for use in hybrid vehicles.

### DETAILED DESCRIPTION OF THE INVENTION

Special attention is now called to the fact that preferred hydraulic jack embodiments of the invention use a variation of the above-mentioned prior art Torvec long-piston hydraulic machine. Commercial-quality prototypes of these Torvec long-piston hydraulic machines have already been successfully built and tested in both large SUVs (sport utility vehicles) and small trucks, and while these new and unusual hydraulic machines have not yet enjoyed wide publicity, they are the preferred hydraulic machines for use with the invention described herein. The preference for this design of hydraulic machine cannot be over emphasized, since presently available commercial hydraulic pumps and motors are considered unacceptable for use with the subject invention because: (1) they are much larger and much heavier than the Torvec long-piston machines; (2) they are incapable of providing the high speeds needed for automotive use; (3) they do not have the start-up torque capabilities of the Torvec long-piston machines; (4) their “break-away” torque makes them inappropriate for the invention, requiring tens of pounds of force to begin to turn their drive shafts even when unloaded, whereas the unloaded drive shaft of a Torvec long-piston machine can be rotated by hand or finger grip; and (5) the volumetric efficiency of present commercial hydraulic machines is poor at low swash plate angles, whereas in actual testing, a Torvec long-piston hydraulic machine produced 2000 psi or more at a swash plate angle of 1.5° with an input speed of 1700 rpm, registering a very high volumetric efficiency at this small angle. With these just-listed deficiencies, if such standard hydraulic machines were to be used in the subject transmission, many of the advantages of the invention would be lost, e.g., the invention's neutral “no-load” condition could not be achieved, the vehicle's brake would have to be applied to avoid vehicle “creep” that wastes fuel when standing in traffic on level ground, etc.

While the orbital gearing of the transmission of the present invention is preferably connected at all times to the rotary control device, i.e., the hydraulic jack machine or the electrically braked magnetic wheel, the only notable load provided by these resistive loads occurs when the rotary control device is activated and adjusted to change the transmission gear ratios during vehicle operation. This resistive load provides a resistance torque that gradually slows the speed of rotation of the control gear through a continuum of decreasing speeds that begin when the swash plate is tipped and/or the fluid control valve adjusted, or as soon as the electric control coil is energized on the magnetic brake. The progressive increase in this resistance torque causes a proportionally progressive slow-down of the control gear. The slow-down of the control gear creates driving torque from the transmission output through an infinitely-varying gear ratio that begins, momentarily, from ∞ 1-300:1 when first initiated, and ends when the control gear is brought to a stop, producing a transmission output at a predetermined overdrive ratio (e.g., 0.7:1).

For preferred use in most vehicles, the input drive of the primary engine is also directed to the sun gear of a single planetary complex having an outside ring gear. The planet carrier of this planetary complex delivers the output of the transmission, while the ring gear is connected to the output gear of the orbital gear complex. As is well known in the art, when the planet carrier is stopped (e.g., when the vehicle is standing still), the ring gear runs backwards in response to the engine input to the sun gear of the planetary complex. When resistive torque begins to slow down the rotation of the control gear of the orbital gear complex, this negative rotation of the ring gear results in a torque feedback that extends the period of infinitely-variable gear reduction as the increasing resistive torque developed by the hydraulic jack machine slows the rotation of the control gear of the orbital gear complex.

In the hydraulic jack versions of the present invention, the hydraulic machine is not acting like a conventional hydraulic pump or motor. In no way is the hydraulic machine used to drive the vehicle. Instead, its sole purpose is to create a controlled resistive torque. That is, each infinitely-variable movement of the swash plate and/or the fluid valve of the hydraulic machine results in a change in the level of hydraulic pressure in the pistons of the hydraulic jack machine, and that pressure acts solely as resistance torque to slow the rotation of the jack machine.

With the preferred hydraulic jack embodiment of the invention, the hydraulic jack machine operates with a controlled minimum volume of fluid, and the minimal fluid passage that connects the input and output ports of the jack machine is closed off by an electronically-controlled pressure valve. When the vehicle is standing still with the engine operating, the swash plate of the jack machine is set at its 0° position, and the drive shaft of the jack machine is turning freely with minimal use of energy. When vehicle acceleration is desired, activation of the swash plate and pressure valve of the hydraulic jack machine instantly creates a resistive pressure of the hydraulic fluid that provides a smooth and quiet startup. Thereafter, the swash plate angle and the fluid valve are adjusted to reduce the flow of fluid between the high and low pressure sides of the hydraulic machine and incrementally increase the resistance torque that slows the rotation of the control gear.

A transmission of the present invention provides a significant gain in engine efficiency by using the simple rotary control device, i.e., the just-described simplified hydraulic jack or electro-magnetic brake apparatus, rather than the vehicle engine as the primary means for vehicle acceleration. Efficiency is increased during all accelerations up to highway cruising speeds because: (1) the vehicle engine remains at idle speeds or at a slightly increased rpm level within a continuum of relatively low rpms (preferably 750 to about 1500 rpm at a rate of typically 75-100 rpm/sec), and at the same time (2) the simplified transmission provides consecutive infinitely-variable increases in output rpm while concomitantly providing consecutive proportional infinitely-variable decreases in torque (through gear ratio decreases). Because the transmission generates such large starting torques at very low vehicle speeds, and because the changes in torque and vehicle speed remain proportional, the horsepower expended by the engine may thereby be more closely matched to the needs dictated by road and traffic conditions.

The hydraulic jack is only active when providing the infinitely-decreasing gear reduction during the acceleration process, and only a very small part of the engine horsepower is expended in slowing the rotation of the shaft of the hydraulic jack. When the vehicle is stopped, the swash plate is returned to 0° and the pressure valve is opened, deactivating the hydraulic jack, and the deactivated hydraulics consume minimal, if any, horsepower. When the vehicle is at cruising speeds, the hydraulics are pressurized and remain locked to hold the control gear in its stopped position, acting with 100% efficiency (like an engaged clutch) and consuming only a fractional horsepower that also includes the energy required for the charge pump to replenish the fluid lost in blow-by.

Similarly, in the magnetic wheel version of the transmission, the electro-magnetic brake is only active when the infinitely-variable increase of electric current in the coil is creating ever-increasing levels of electro-magnetic force that act to oppose the magnetic fields of the magnets of the magnetic wheel, creating a resistance torque that slows the rotation of the magnetic wheel to provide the infinitely-decreasing gear reduction during the acceleration process. When the magnetic wheel and control gear are stopped and cruising speeds are attained, a lock is applied to the magnetic wheel, holding it in its stopped position, and the coil is de-energized. During slowdown conditions, the lock is deactivated and the magnetic wheel turns freely with the control gear.

In actual vehicle testing, a prototype of the basic hydraulic jack transmission of the present invention (i.e., without the planetary gear set) reasonably accelerated a light truck to 30 mph with a relatively minor increase in engine speed (e.g., 750-1000 rpm at about 75-100 rpm/sec). This is a significant improvement over the relative inefficiency of present conventional transmissions that achieve vehicle acceleration only by rapidly and continuously increasing engine speed to well over 1500 rpm during several iterations, unnecessarily wasting engine efficiency. In a further improvement confirmed by actual in-vehicle testing, this same prototype transmission was found to consume fuel at approximately half the rate of a conventional automatic transmission when the vehicle is standing in traffic (e.g., stopped at a traffic light).

Of course, many operators lack the expertise or patience to learn the manual control procedures just explained above, and many others are unnecessarily “heavy footed” on the accelerator pedal. Therefore, in one embodiment of the present invention, vehicle operation is computer-assisted. Such computer programs sense the angle of the accelerator pedal, as well as the rate at which this angle has been increased or decreased by the operator, to progressively select engine speeds from a continuum of relatively low rpm, the rate of engine speed progression being controlled to optimize the horsepower/fuel consumption for the desired acceleration rate indicated by the operator's actions. After the vehicle reaches a desired speed level, as indicated by the operator's released angle of the accelerator, the computer backs off the engine to the lowest rpm level necessary to maintain that speed.

Recent Torvec IVT transmissions have been much smaller and lighter than the conventional transmissions that they replace, and several embodiments of the present invention are even smaller and have significantly less volume and weight than the earlier IVT designs, since they omit one complete hydraulic machine.

### Basic Hydraulic Jack Transmission

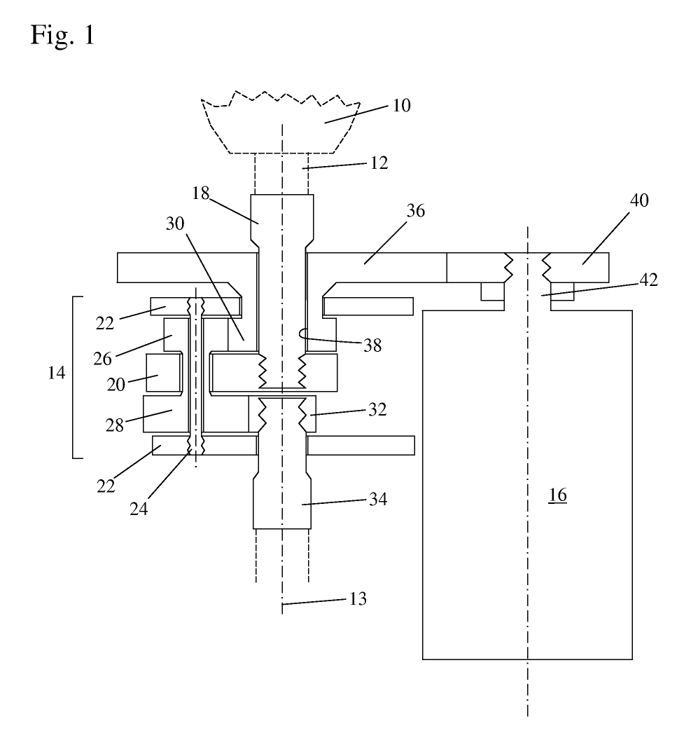

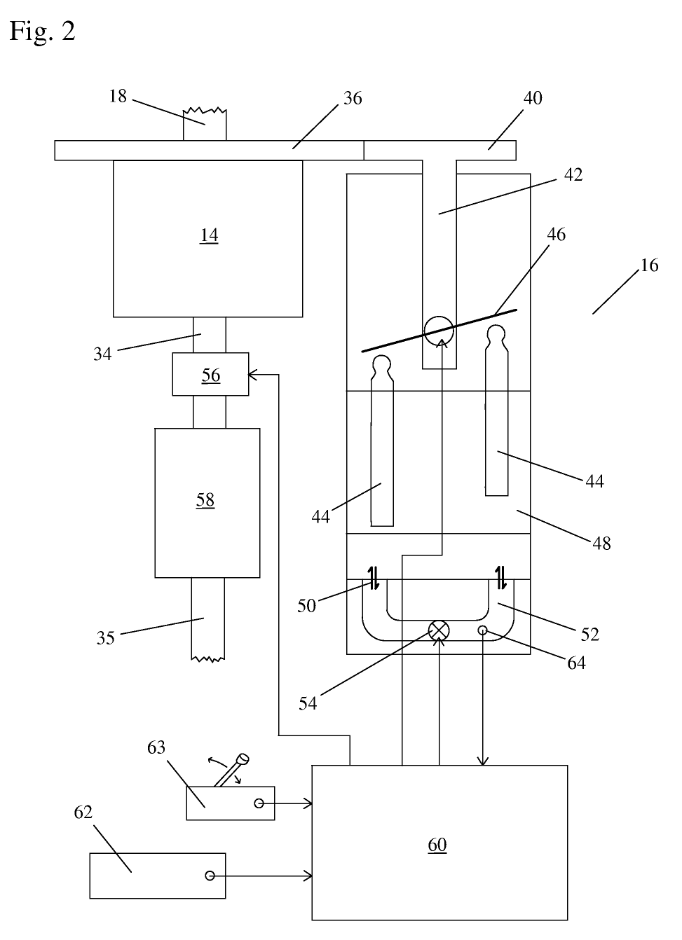

FIG. 1 and FIG. 2 are schematic diagrams of a remarkably small and compact transmission in embodiments of the hydraulic jack version of the present invention. The transmission is attached to the crankshaft 12 of a primary engine 10 that provides an input for an orbital gear complex 14, which is in combination with a rotary control device that is disclosed in this preferred embodiment as a hydraulic jack machine 16. An input shaft 18 is splined to engine crankshaft 12, both of which are aligned along a first axis 13. A central drive plate 20 is positioned between the two end plates 22, and these just-named three elements together form the orbital web of the transmission that also rotates about first axis 13. Input shaft 18 is also splined to central drive plate 20. End plates 22 support the respective ends of orbit shaft 24 that carries a cluster gear arrangement including cluster gears 26 and cluster gears 28. While a preferred orbital gear complex includes at least two or three sets of orbit shafts 24 and cluster gears 26/28, only one set is shown for clarity. Also, engine crankshaft 12 may alternatively be splined directly to the central drive plate 20. Central drive plate 20 has openings to provide clearance for cluster gears 26/28, and a control gear 30 meshes with cluster gears 26, while cluster gears 28 mesh with an output gear 32 coupled to a transmission output shaft 34 that, in turn, is connected to a vehicle drive shaft 35 (as is explained in further detail below).

Control gear 30 is fixed to a control drive gear 36, and both control gears 30, 36 are similarly fixed to a hollow shaft 38 that circumscribes transmission input shaft 18. Control drive gear 36 is in mesh with a hydraulic drive gear 40 fixed to the drive shaft 42 of hydraulic jack machine 16 that creates the resistance torque to control the output of orbital gear complex 14. Control gear 30 is larger than cluster gear 26, and cluster gear 28 is larger than output gear 32.

In one embodiment of the present invention, the gear tooth ratios for the orbital gearing are as follows, with reference numerals from FIG. 1 and FIG. 2:

| | Gear | No. of Teeth |
|---|---|---|
| a. | Control gear 30 | 32 |
| b. | Cluster gear 26 (in mesh w/30) | 19 |
| c. | Cluster gear 28 (fixed to 26) | 33 |
| d. | Output gear 32 (in mesh w/28) | 22 |
| e. | Control drive gear 36 (fixed to 30) | 60 |
| f. | Hyd. machine drive gear 40 (in mesh w/36) | 30 |

Hydraulic jack machine 16, which operates as the transmission's rotary control device in several of the disclosed embodiments, includes a plurality of pistons 44 arranged in cylinders (not individually shown). The stroke of the pistons 44 is controlled by the position of an adjustable swash plate 46 that rotates with drive shaft 42 and hydraulic drive gear 40. The cylinder block 48 includes a cylinder for each piston, each cylinder having input and output ports 50 connected through only a very minimal passage 52 closable by a fluid pressure valve 54 that also serves as a pressure relief valve (e.g., for avoiding increases in pressure above 4000 psi within machine 16).

When swash plate 46 is set at 0°, drive shaft 42 and swash plate 46 may freely rotate without resulting in any significant increase of fluid pressure in any portion of hydraulic machine 16, including minimal passage 52. However, when acceleration is desired, swash plate 46 is moved to a predetermined angle and pressure valve 54 is adjusted to restrict flow through minimal passage 52, increasing hydraulic pressure within the hydraulic machine and slowing the rotation of swash plate 46, drive shaft 42, hydraulic drive gear 40, and control drive gear 36 to provide a resistance torque that decreases rotation of control gear 30 proportional to the increase of the resistance torque. This resistance torque varies directly with the fluid pressure in hydraulic machine 16, and that pressure is incrementally increased until the adjustment of swash plate 46 and the closure of pressure valve 54 creates sufficient resistance torque to prevent rotation of control gear 30 and cause the transmission to drive the vehicle in its overdrive ratio (e.g., 0.7:1).

In the disclosed preferred embodiments, output shaft 34 from orbital gear complex 14 preferably connects through a shifting fork mechanism 56 to a standard “forward/reverse” gear complex 58, this gear change being conventionally controlled by a standard shift lever. While the final output of the forward and/or the reverse gearing of complex 58 can remain at 1:1 with the transmission output, some differing output gear ratios may be desired in some designs. Also, a computer 60 preferably monitors (a) the vehicle accelerator pedal 62 (both position and rate of change), (b) a manual shift lever 63, and (c) hydraulic fluid pressure in hydraulic machine 16 by a fluid pressure sensor 64 to control (d) adjustment of swash plate 46, (e) adjustment of fluid pressure valve 54, and (f) operation of clutch 56.

The following sections relate to the operation of the inventive transmission. These operational functions are described with reference to the just-described basic hydraulic jack embodiment. However, it should be appreciated that these same operational functions apply similarly to all of the embodiments of the invention, including the magnetic brake and feedback embodiments discussed below.

### Start-Up

When the vehicle is stationary and the engine is first started, the following events preferably occur: The engine begins to operate at idle (e.g., 750 rpm). The orbital web 20, 22 of small gear complex 14 rotates with engine crankshaft 12 at engine speed. The wheels of the parked vehicle are standing still on the terrain and, since transmission output gear 32 is connected to the vehicle drive shaft 35, output gear 32 is held in a stopped condition. With orbital web 20, 22 rotating orbit shaft 24 and cluster gears 26, 28 about first axis 13 while output gear 32 is held stopped, cluster gear 28 rolls around stopped output gear 32 as the orbital web moves with the engine drive. Under these conditions, with the preferred gear ratios indicated above and with swash plate 46 of hydraulic jack machine 16 set at 0°, control gear 30 rotates at approximately one-half the engine input speed (e.g., 375 rpm), and hydraulic drive gear 40, shaft 42, and swash plate 46 all merely rotate freely at some predetermined overdrive rate faster than the speed of control gear 30, adding only a minimal frictional load. Once again, special attention is called to the fact that the hydraulic machine disclosed in a preferred embodiment herein is a variation of the above-mentioned prior art Torvec long-piston hydraulic machine disclosed in U.S. Pat. No. 6,983,680 and U.S. 2004/0168567, which assures the successful operation of the just-described neutral “minimal-load” condition.

### From Standing Stop

Upon vehicle startup from a standing stop, the following events preferably occur: While engine 10 remains at idle (e.g., 750 rpm), swash plate 46 is initially moved to a predetermined angle in the forward direction, either manually or under computer control in response to the depression of accelerator pedal 62, and pressure valve 54 is adjusted to begin incrementally blocking off minimal passage 52. Pressure immediately begins to build up within hydraulic jack machine 16, and this same immediate pressure increase causes a slow-down of control gear 30 from its free-wheeling speed at approximately one-half the idling speed of the engine (e.g., 375 rpm). Gear complex 14 responds to this slow-down of control gear 30 by creating a momentary near-infinite gear reduction at the output gear that, in a fraction of a second, drops to 1000-300:1 gear reduction, starting the vehicle's wheels to turn at very slow rpm with very high torque.

Thereafter, the vehicle is accelerated in response to the continued adjustments of swash plate 46 and pressure valve 54. However, it is important to note that this acceleration rate is relatively fast. This increasing pressure creates resistance torque that opposes and slows the rotation of swash plate 46, hydraulic machine drive shaft 42, hydraulic drive gear 40, control drive gear 36, and control gear 30. The increasing slow-down of control gear 30 results in the concomitant gradual increase in the rotation of transmission output shaft 34 at the just-described high gear ratio that quickly drops to about 30-20:1, delivering the proportional engine torque and starting to move the vehicle wheels.

This just-described process continues as the vehicle accelerates, further lowering the numerical gear ratio, until the vehicle reaches around 30-50 mph. At this point, the following conditions occur almost simultaneously: (a) control gear 30 stops; (b) swash plate 46 and fluid valve 54 are held in their respective adjusted positions; (c) the hydraulic pressure in hydraulic jack machine 16 remains “locked” (like a hydraulic clutch), exerting a constant back pressure that maintains control gear 30 in its stopped condition; and (d) transmission output gear 32 is running at a predetermined overdrive condition as efficiently as if it were held by a clutch.

The locked condition of hydraulic machine 16 is maintained as the continuing blow-by (e.g., less than 1 gal/min at vehicle speeds of 50 mph or faster) is conventionally replaced to the low pressure (suction) side of the jack machine by a small charge pump.

### When Cruising

At highway cruising speeds (i.e., with swash plate 46 and control gear 30 held in limit positions to maintain a predetermined cruising pressure), when greater drive torque is required, such as for maintaining speed on an incline or passing another vehicle, the operator merely moves shift lever 63 slightly back from its limit position. This is all that is required to move swash plate 46 to a slightly larger angle, reducing the fixed cruising pressure and, thereby, re-starting movement of hydraulic pistons 44 and control gear 30, to increase the transmission gear-ratio and output torque.

The vehicle may be provided with a well-known “cruise control” feature. If so, when traveling under cruise control at some desired cruising speed and the vehicle encounters a hill, the increased load on the transmission is noted by the operator, or through fluid pressure sensor 64 in minimal passage 52 by computer 60, and this pressure increase is compensated by moving swash plate 46 a few degrees either by computer input or by manual movement of shift lever 63 to initiate adjustment of the swash plate angle and fluid control valve. These adjustments result in only a slight increase in engine speed and an increase in output torque, until the vehicle again reaches the desired cruising speed and the pressure within the hydraulic system once again becomes balanced. Swash plate 46 and fluid valve 54 are maintained in optimum positions corresponding to the pressure required to provide sufficient resistance torque to once again stop control gear 30 and maintain the vehicle at its desired speed.

When it is desired to slow the vehicle from a cruising speed, accelerator pedal 62 is released and the swash plate and fluid valve are adjusted to increase braking torque through the resulting rapidly increasing gear-ratios. Under full braking conditions, the swash plate is moved to the 0° position and the fluid valve is opened so that the hydraulic jack becomes a disengaged clutch to prevent the engine from stalling.

Again, special attention is called to the fact that hydraulic jack machine 16 is not operating like a conventional pump or motor, and the increasing resistance torque provided by hydraulic machine 16 is not generated by an increasing flow of hydraulic fluid. To the contrary, as minimal passage 52 between hydraulic input and output ports 50 becomes increasingly blocked by pressure valve 54, the flow of hydraulic fluid steadily reduces until the pressure in hydraulic machine 16 creates sufficient resistive torque to prevent rotation of control gear 30 and the hydraulics, although still under pressure, cease to flow. Under this “locked” condition, the only flow of fluid is a relatively small blow-by in response to the pressure being developed within hydraulic jack machine 16 accompanied by a concomitant replenishing of the blow-by to the low pressure side from a conventional charge pump. In effect, as indicated above, hydraulic jack machine 16 operates like a hydraulic clutch. Each successive movement of swash plate 46 and/or closing adjustment of fluid valve 54 causes movement of the pistons of the machine to create ever-increasing levels of hydraulic pressure that act as resistance torque to slow the rotation of control gear 30.

Special attention is also called to another very important feature of the invention. As indicated above, when the vehicle is stopped and there is no movement of output gear 32, the orbital gearing creates a mechanical advantage of the engine input to cause control gear 30 to rotate at a predetermined reduction of the idling engine speed. The gear ratio between hydraulic drive gear 42 and control-drive-gear 36/control gear 30 is intentionally selected to create that same mechanical advantage for the resistance torque pressure developed by hydraulic jack machine 16. Thus, in effect, the hydraulic resistance torque that slows control gear 30 enters the gear complex at a reduction that matches the engine torque reduction. As just explained above, the preferred embodiment disclosed provides the desired engine-matching resistance torque by selecting a similar 2:1 gear reduction between hydraulic drive gear 40 and control drive gear 36. However, this reduction can be made even higher to require less initial resistance torque from jack machine 16 to match engine torque (for instance, where the transmission is being used with a diesel engine).

In actual vehicle testing, a vehicle equipped with the just-described hydraulic jack version of the present invention readily attained a speed of 22 mph while the engine was maintained at a little over 750 rpm. However, the acceleration of the vehicle from a stop to this speed may take as long as 10-12 seconds depending on road conditions. Since most operators prefer a faster acceleration, this preference may be achieved manually by no more than a minor increase in the angle of the accelerator pedal. Computer control 60 senses the indicated pedal angle to increase acceleration at a more generally acceptable rate (e.g., 100 rpm/sec). This increased acceleration is achieved without the conventional racing of the engine to over 2000 rpm. Instead, the operator or computer progressively selects relatively low levels of increasing engine rpm (e.g., from a continuum of 750-1500 rpm). The rate of this engine speed progression is controlled to optimize the horsepower/fuel consumption for the desired acceleration rate, as indicated by the depression angle of the accelerator. After the vehicle reaches a desired speed level, again indicated by accelerator position, the engine speed is backed off to the lowest rpm level necessary to maintain that attained speed.

As indicated above, it should be remembered that these same just-described operational functions apply equally to all of the embodiments of the invention, including the following magnetic brake and feedback embodiments discussed below.

### Magnetic Brake Transmission

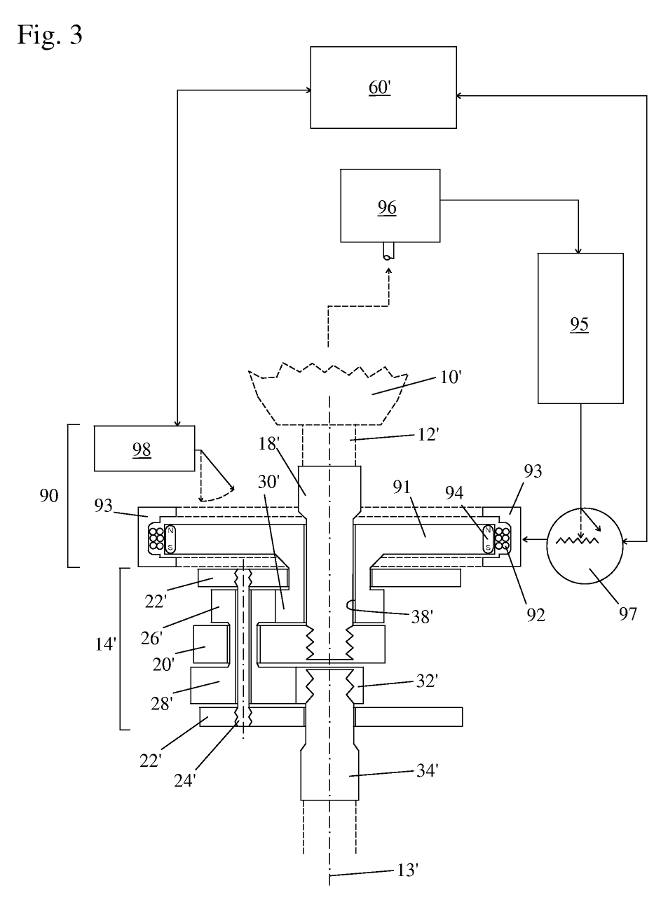

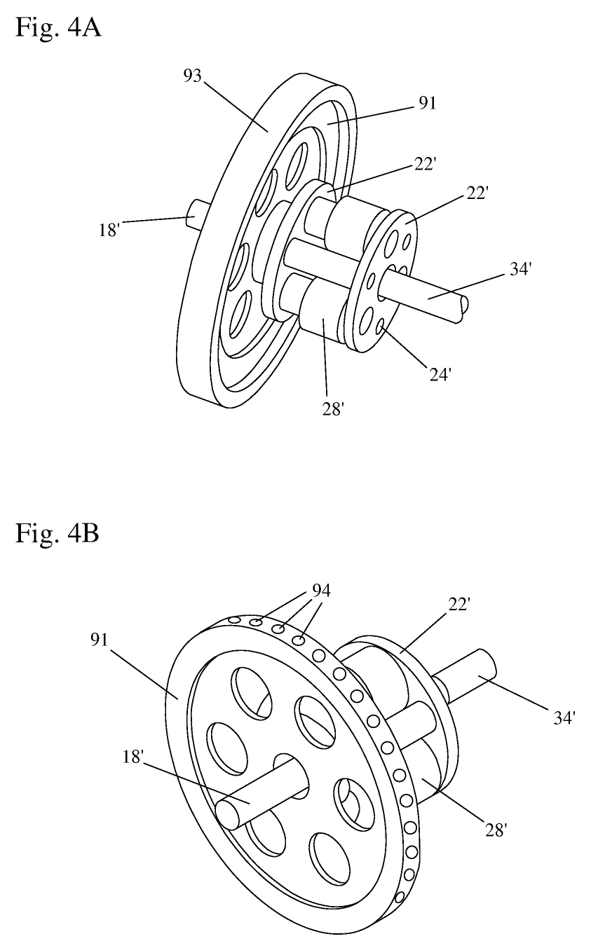

A magnetic brake version of the invention operates functionally in the same manner as the hydraulic brake version shown in FIGS. 1 and 2 and described above. The significant differences between these two versions are selectively illustrated in FIGS. 3, 4A and 4B.

In FIG. 3, the engine 10′, crankshaft 12′, and entire orbital gear complex 14′ are essentially identical to those similarly numbered parts shown in FIGS. 1 and 2. The major difference is the replacement of hydraulic jack machine 16 (FIG. 1) with magnetic wheel/coil apparatus 90 (FIG. 3). Apparatus 90, which is also shown in perspective views in 4A and 4B, includes a magnetic wheel 91 that is fixed for rotation with control gear 30′ and is surrounded by an electric coil 92 that is held by a circumferential coil support 93. The outer circumference of magnetic wheel 91 is lined with a plurality of permanent magnets 94 each of which is positioned with its respective magnetic field in a similar alignment, as indicated by the N (north) and S (south) letters in FIG. 3. Coil 92 is supplied with varying levels of electric current through circuitry shown symbolically as a switch/rheostat 97 by battery 95 that is charged by generator 96 that is driven by engine 10′ in the conventional well known manner.

As in the earlier-described hydraulic jack embodiment, the computer 60′ of this magnetic brake embodiment is similarly responsive to vehicle speed-change apparatus and sensors (not shown in this view, but see FIG. 2) and a magnetic wheel lock 98 to control the operation of magnetic wheel/coil apparatus 90.

As just indicated above, the operation of this embodiment is similar to that explained above. Namely, when the vehicle is stopped and engine 10′ is running, magnetic wheel 91 normally is allowed to freely rotate with control gear 30′ at a reduction created by the orbiting cluster gears 26′ and 28′ at approximately one-half the speed of central drive plate 20′ that is driven directly by input shaft 18′ and engine crankshaft 12′. Acceleration of the vehicle is similarly accomplished by the slowing and stopping of control gear 30′, using an electro-magnetically generated reactive torque rather than a hydraulically generated reactive torque. Increasing current in coil 92 generates an increasing magnetic field that opposes the fields of each of the permanent magnets 94, creating increased resistive torque that slows the rotation of magnetic wheel 91 and control gear 30′. This increasing resistive torque causes the successive infinite gear reductions at output gear 32′ that result in the increase in vehicle speed in the manner explained in detail above. This process continues until control gear 30′ is stopped and gear reduction of the drive reaches an overdrive condition and the vehicle reaches cruising speed.

A lock apparatus 98 is associated with magnetic wheel 91. Lock 98 is normally deactivated (as indicated by the solid arrow) and is only activated (as indicated by the dashed arrow) when magnetic wheel 91 and control gear 30′ are stopped and the vehicle reaches cruising speed. With magnetic wheel 91 locked in its stopped position, switch 97 is opened, closing off the current to coil 92. Thus lock apparatus 98 serves the same function as the hydraulic pressure in the earlier embodiment explained above when hydraulic machine 16 remains “locked” (like a hydraulic clutch), thereby exerting a constant back pressure that maintains control gear 30′ in its stopped condition; and transmission output gear 32′ is running at a predetermined overdrive condition as efficiently as if it were held by a clutch.

Lock apparatus 98 is only illustrated in a block diagram, and persons skilled in the art will appreciate that this apparatus can be created with any number of well known mechanical arrangements, e.g., pawls, ratchets, balls, detents, clamps, hooks, latches, etc., preferably engaged and disengaged electro-magnetically.

Although magnetic wheel 91 is shown fixed to control gear 30′, it may be desirable to provide some additional mechanical advantage for the resistance torque being created by magnetic wheel/coil apparatus 90 to intentionally create the same mechanical advantage for the resistance torque being delivered to control gear 30′ that the orbital gearing creates for the engine input being delivered to control gear 30′. With this mechanical advantage, the magnetic resistance torque that slows control gear 30 enters the gear complex at a reduction that matches the engine torque reduction. For instance, similar to the hydraulic embodiment explained above, magnetic wheel 91 could be mounted on an independent axle, being connected to control gear 30′ through a control drive gear similar to the gear reduction arrangement shown in FIG. 1 between hydraulic drive gear 40 and control drive gear 36. Such an additional mechanical advantage may be particularly desirable to match engine torque if the transmission is being used with a diesel engine.

### Resistive Torque Feedback

Although the embodiments just described above operate satisfactorily under many conditions, for automotive vehicles such as passenger cars, SUVs, and trucks, faster acceleration can be attained with less horsepower with the following feedback embodiment of the invention. The only change from the embodiments discussed above is the inclusion of a single planetary gear complex between the orbital gear complex and the vehicle's final drive.

In this preferred embodiment, the engine torque is split at all times between two mechanical paths: a first path drives the web of a minimal orbiter gear set (substantially identical to the orbiter described above), and a second path drives the sun gear of a single conventional planetary gear set having an outside ring gear that meshes with a sun gear through a set of planetary gears held by a carrier. The output gear of the orbital gear set is connected to the ring gear of the planetary gear set, and the planet carrier of the planetary gear set is connected to the vehicle's drive shaft. When the parked vehicle's wheels are standing still on the terrain, the planet carrier is held stationary and the engine input to the sun gear causes the ring gear of the planetary to rotate in a reverse direction. This reverse motion of the ring gear is “fed back” through the output gear of the orbiter and the cluster gears to the control gear of the orbiter. Under these start-up conditions, the rotation of the planetary ring gear is added to the rotation of the orbiter control gear so that the latter rotates at approximately 55% of the engine input speed and in the same direction. Under these same start-up conditions, the rotary control device (i.e., the hydraulic jack in the disclosed preferred embodiment) is effectively deactivated, allowing the hydraulic drive gears and the shaft of the hydraulic jack to merely rotate freely with the control gear, adding only a minimal frictional load.

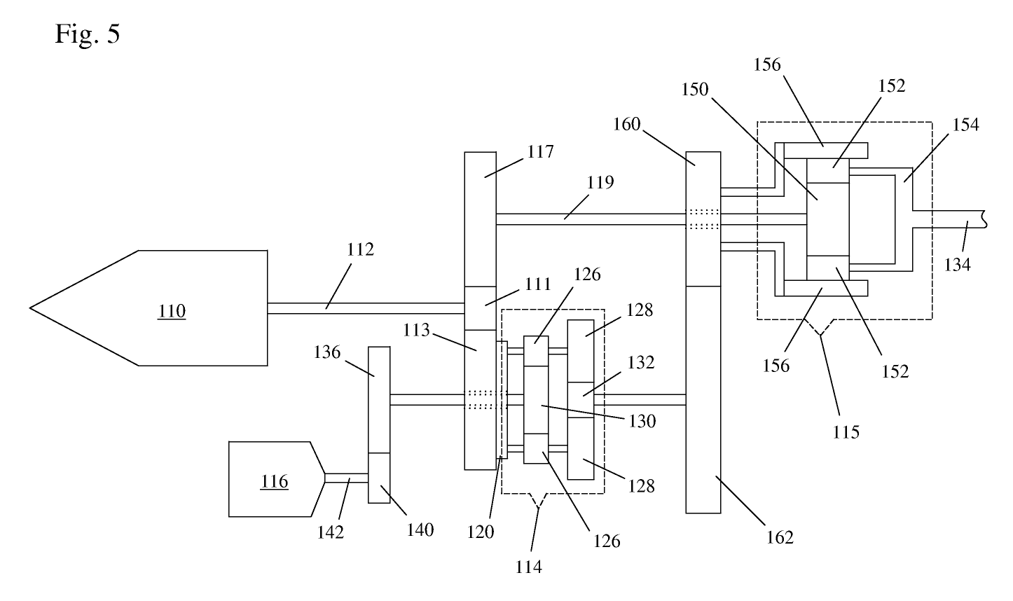

This preferred embodiment is illustrated schematically in FIG. 5 in which the crankshaft 112 of a primary engine 110 is fixed to an engine drive gear 111 that engages both an orbiter drive gear 113 and a planetary drive gear 117 to provide respective inputs for an orbital gear complex 114 and a planetary gear complex 115. Orbiter drive gear 113 is fixed to a drive plate 120 that carries the cluster gears 126/128 on the orbital web that, in turn, orbits around both the control gear 130 and the output gear 132 of orbital gear complex 114. Planetary drive gear 117 is fixed to an input shaft 119 that connects to the sun gear 150 that engages the planet gears 152 of a planet carrier 154 that is also fixed to transmission output shaft 134. This conventional planetary gear set also includes an outside ring gear 156 with internal teeth that engage with planet gears 152. Ring gear 156 is fixed to a first feedback gear 160 that, in turn, mates with a second feedback gear 162 that is connected to output gear 132 of orbital gear complex 114.

In this preferred embodiment of the present invention, the hydraulic jack machine 116 is exactly the same as hydraulic jack machine 16 described above, and the gear tooth ratios for the orbital gear complex 114 are the same as orbital gear complex 14 described above, while the gear tooth ratios for the traditional planetary are as follows, with reference numerals from FIG. 5:

| | Gear | No. of Teeth |
|---|---|---|
| a. | Sun gear 150 | 30 |
| b. | Ring gear 156 | 72 |
| c. | Planet (idler) gears 152 (in mesh w/150 and 156) | — |

In the following description, the other gear ratios described are exemplary only, and other ratios may be selected according to various circumstances and needs.

With engine 110 operating, engine drive gear 111 drives both orbiter drive gear 113 and planetary drive gear 117 at a 2:1 reduction, providing simultaneous input for (a) rotating web drive plate 120 and cluster gears 126/128 of orbital gear complex 114 and (b) rotating sun gear 150 of planetary gear complex 115, each at half the engine speed. When the vehicle is standing still, the vehicle wheels are not moving and planet carrier 154 is held stationary. Under these conditions, ring gear 156 rotates at −2.4:1 of the engine input to sun gear 150, and this reverse rotation is delivered through first and second feedback gears 160, 162 to output gear 132 of orbital gear complex 114 at a 2:1 ratio.

The operation of orbital gear complex 114 is similar to that described above regarding the operation of orbital gear complex 14. Namely, when output gear 132 is held stopped and the engine drive is rotating web drive plate 120 and cluster gears 126/128, cluster gears 126/128 roll around stopped output gear 132, causing control gear 130 to rotate at approximately one-half the engine input speed (with the preferred gear ratios indicated above). However, the rotation of output gear 132 by ring gear 156 increases the rotation of control gear 130 to approximately 55% of the engine input speed. The rotation of control gear 130 is delivered through a control drive gear 136 and a hydraulic jack drive gear 140 to the drive shaft 142 of hydraulic jack machine 116. As explained above, under these conditions, the swash plate of jack machine 116 is set at 0°, and jack drive gear 140, shaft 142, and the swash plate all merely rotate freely at some predetermined overdrive rate faster than the speed of control gear 130, adding only a minimal frictional load.

Next, as explained above, adjustment of the swash plate and control valve of jack machine 116 gradually increases hydraulic pressure within jack machine 116, creating an increasing resistance torque that slows the rotation of control gear 130. This causes, initially, a very high gear reduction of the input drive that then decreases proportional to the slowing of the speed of rotation of control gear 130 until control gear 130 stops, and the transmission reaches a predetermined overdrive condition.

As the vehicle begins to move and increase in speed, planet carrier 154 increases in speed, while the reverse rotation of ring gear 156 slows proportionally. When the speed of planet carrier 154 has increased sufficiently to stop the reverse rotation of ring gear 156, the output ratio of planet carrier 154 is 3.4:1 of the engine input to sun gear 150. Thereafter, the output ratio of planet carrier 154 continuously decreases, until ring gear 156 rotates at the same speed as the engine input to sun gear 150 and the output ratio of planet carrier 154 is 1:1 to the engine input. At this time, output gear 132 of orbiter 114 continues to moves ring gear 156 of planetary 115 faster than the engine input to sun gear 150, until the output ratio of planet carrier 154 finally becomes a 0.7:1 overdrive.

The slow-down of the negative rotation, stopping, and rotational change of ring gear 156 of planetary complex 115 occurs during the period when orbital gear complex 114 is developing acceleration torque. The feedback from ring gear 156 (a) slows down the rate at which the resistance torque of hydraulic jack machine 116 is decreasing the speed of the control gear 130, and (b) slows down the initial speed changes of the output gear 132 of orbital gear complex 114. Since the rotational speed and torque changes of the ring gear 156 are superimposed on the output gear 132, the acceleration torque of the transmission (beginning with an extremely high gear-ratio reduction down to overdrive) is effectively extended throughout a longer start-up period that continues until the vehicle has reached a higher speed than the speed at which orbital gear complex 114 alone would achieve such overdrive condition.

To provide some appreciation of the effect of this extension, in actual testing of the basic jack embodiment with the vehicle engine maintained near idle speed (e.g., 750 rpm), the transmission progressed from the highest gear-ratio reduction to overdrive by the time the vehicle had reached a speed of 12 mph. The just-described feedback embodiment delays this progression so that, with the engine near idle, overdrive is not reached until the vehicle reaches 25 mph; and with only a relatively small increase in engine speed (up to 1500 rpm), overdrive is delayed until 48 mph.

### Accumulator

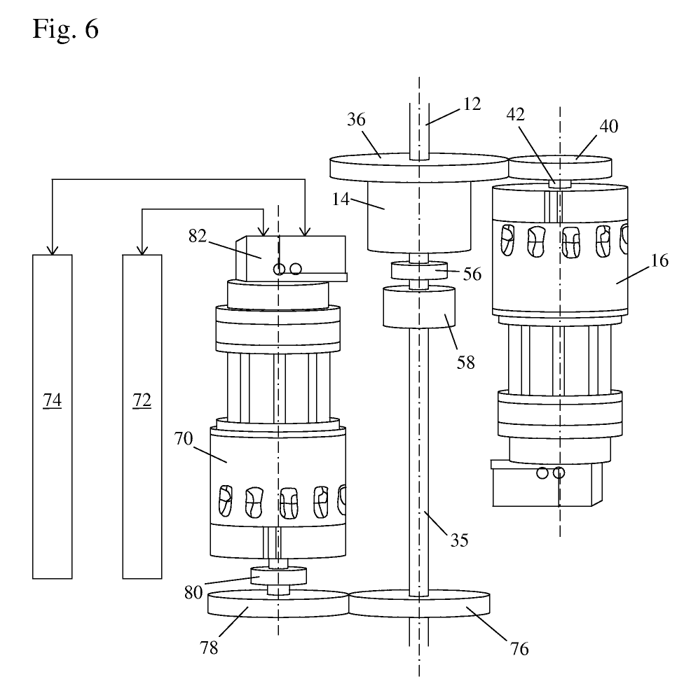

Another embodiment of the present invention, shown in partially schematic FIG. 6, includes an apparatus that permits operation in regeneration modes similar to those used in well-known “hybrid” vehicle designs. An accumulator system as described below may be added to any of the previously-described embodiments of the present invention.

In this embodiment, the hydraulic brake version of the transmission converts torque from engine crankshaft 12 to vehicle drive shaft 35 in the manner just explained above with reference to FIGS. 1 and 2. A second hydraulic machine, pump/motor 70 is added along with a fluid storage tank 72, a fluid pressure tank 74, accumulator transfer gears 76, 78, a clutch 80, and an accumulator control valve 82.

Whenever the vehicle is braking or coasting, accumulator control valve 82 interconnects hydraulic pump/motor 70 to accumulator tanks 72, 74, and, simultaneously, clutch 80 connects transfer gears 76, 78 to the drive shaft of hydraulic pump/motor 70. During such coasting or braking conditions, the rotation of vehicle drive shaft 35 is increased by gears 76, 78 to energize pump/motor 70 which acts like a regeneration pump to draw fluid from storage tank 72 and deliver it under pressure to pressure tank 74. Pressure tank 74 is primarily a steel tube, capped at each end with the interior of pressure tank 74 including a bladder that is filled with a compressible gas in the manner well-known in the art. Regenerative fluid enters pressure tank 74 under pressure that begins to compress the gas in the bladder until pressure tank 74 is full.

Storage tank 72 is preferably similar to pressure tank 74 except that it contains no gas-filled bladder and it is initially filled with fluid sufficient for the normal operation of the regeneration system. For many vehicles, elongated tubes that include storage tank 72 and pressure tank 74 may be approximately 8′-10′ long and may be positioned along side each of the respective side rails of the vehicle's frame.

When it is desired to restart or reaccelerate the vehicle, hydraulic machine 16 operates in the manner explained above, while clutch 80 is engaged and valve 82 is moved to its open position. The pressurized fluid stored in pressure tank 74 is released to energize hydraulic pump/motor 70, which now acts like a regeneration motor, adding driving torque to engine drive shaft 35 through the reduction of transfer gears 78, 76. During the time that pressurized fluid is being delivered from pressure tank 74, the regeneration system remains activated (i.e., valve 82 remains open) so that the regeneration fluid is returned to storage tank 72, while engine 10 remains at idle speed. As soon as the vehicle reaches a desired operating speed, or as soon as pressure tank 74 is depleted of pressurized fluid, whichever occurs first, the regeneration circuit is closed off (i.e., valve 82 is closed and clutch 80 is disengaged), and the speed of engine 10 and the transmission are returned to normal operation.

As soon as pressure tank 74 is empty, or as soon as the vehicle reaches a predetermined minimal operating speed, whichever occurs first, the regeneration circuit is closed off (i.e., valve 82 is moved to its closed position and clutch 80 is disengaged), and the transmission is returned to normal operation (i.e., the swash plates of hydraulic machines 16 and 70 are reoriented to their respective normal positions) based upon the vehicle speed condition then prevailing.

In an alternative embodiment, the embodiment discussed above and shown in FIG. 5 has been modified for use in a vehicle being designed for NASA for use on the moon. Namely, engine 110 for this “moon modification” is an electric motor; the rotary control device is not hydraulic machine 116 but rather is another electric motor; and, while the gear tooth ratios of planetary gear complex 115 remain as indicated, the gear tooth ratios of orbital gear complex 114 are modified to provide a reduction of the input drive to operate more efficiently under in exceptional conditions of this unusual environment.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A transmission for a primary engine, the transmission comprising:
a rotary control device; and
an orbital gear complex comprising only:
an orbiter web mounted for rotation about a first axis and responsive to an input drive provided by the primary engine;
a control gear mounted for rotation about the first axis and responsive to a control drive provided by the rotary control device;
an output gear mounted on the first axis; and
at least one cluster gear mounted for rotation on an orbit shaft positioned parallel with the first axis and supported on the orbiter web in mesh with only the control gear and the output gear to permit the orbit shaft and the cluster gear to orbit, respectively, the first axis and the control gear and output gear;
wherein a first gear tooth ratio between the cluster gear and the control gear and a second gear tooth ratio between the cluster gear and the output gear are selected such that, when rotation of the control gear is prevented, rotation of the orbiter web produces rotation of the output gear at a predetermined overdrive of the input drive provided by the primary engine.

2. The transmission of claim 1, wherein the rotary control device comprises a resistance apparatus for developing a resistance torque sufficient to match a torque of the primary engine for slowing rotation of the control gear.

3. The transmission of claim 2, wherein the rotary control device is connected to the control gear through a control drive reduction gear at a predetermined ratio.

4. The transmission of claim 3, wherein the control drive reduction gear provides a torque resistance to the rotation of the control gear of at least the same predetermined reduction as input drive torque of the primary engine is provided to the control gear.

5. The transmission of claim 2 further comprising a lock having activated and deactivated conditions, and wherein, when the resistance torque is sufficient to stop the rotation of the control gear, the lock is activated to hold the control gear in its stopped position.

6. The transmission of claim 5, wherein the primary engine and transmission are operatively connected to a plurality of wheels of an automotive vehicle that comprises:
the primary engine;
a vehicle speed-change apparatus controllable by an operator of the vehicle for making desired changes in vehicle operations;
a sensor for monitoring the movement of the control gear; and
a computer with interconnections to the vehicle speed-change apparatus, the primary engine, and the sensor.

7. The transmission of claim 6, wherein the rotary control device and the lock comprise a hydraulic jack.

8. The transmission of claim 7, wherein the hydraulic jack comprises a single hydraulic machine comprising:
a plurality of pistons in cylinders with input and output ports connected through only a minimal passage closable by a fluid valve; and
a drive shaft connected to an adjustable swash plate for varying a hydraulic pressure in the machine.

9. The transmission of claim 8, wherein when the swash plate of the hydraulic jack machine is set at a swash plate angle of 0° and the fluid valve is open, the drive shaft and swash plate are unlocked to freely rotate without causing a significant increase in the hydraulic pressure in the machine.

10. The transmission of claim 9, wherein the fluid valve and the swash plate of the hydraulic jack machine are adjustable such that the hydraulic pressure in the machine is increasable to provide a resistance torque preventing rotation of the control gear, the hydraulic jack machine thereby providing a resistance torque to decrease a rate of rotation of the control gear proportional to the increase of the resistance torque.

11. The transmission of claim 6, wherein when the vehicle is stopped and the primary engine is operating, the computer deactivates the lock and permits the control gear to rotate without resistance torque from the rotary control device.

12. The transmission of claim 11, wherein when activation of the vehicle speed-change apparatus by the operator indicates a desired increase in vehicle speed, the computer initiates the creation of resistive torque by the rotary control device for slowing the speed of rotation of the control gear.

13. The transmission of claim 12, wherein the rotary control device comprises an electro-magnetic brake.

14. The transmission of claim 13, wherein the electro-magnetic brake comprises:
a magnetic wheel connected for rotation with the control gear, the magnetic wheel having at least one magnet mounted in proximity to a circumferential surface thereon;
a source of electrical energy; and
a coil mounted independently of, and proximate to, the magnetic wheel, the coil being responsive to electrical energy for generating a magnetic field aligned to oppose the magnetic alignment of the magnet such that when electrical energy is delivered to the coil, the magnetic field alignments oppose each other with a resistance torque sufficient to match the torque of the primary engine for slowing rotation of the control gear.

15. The transmission of claim 1, wherein the input drive comprises a crankshaft of the primary engine aligned with the first axis, and wherein the orbiter web further comprises:
a pair of separated support elements for mounting the orbit shaft of the cluster gear; and
a drive element fixed to and positioned between the support elements to allow the cluster gear to rotate freely, the drive element being fixed for rotation with the input drive; and
wherein the control gear is mounted on a hollow shaft that circumscribes the crankshaft.

16. The transmission of claim 5, wherein the primary engine and transmission are operatively connected to a plurality of wheels of an automotive vehicle by a vehicle drive shaft, the transmission further comprising:
an accumulator apparatus connectable to the vehicle drive shaft;
an energy storage facility; and
an accumulator control for activating the accumulator apparatus:
to collect energy from the drive shaft when the vehicle is standing or slowing and store collected energy in the storage facility; and
to retrieve energy from the storage facility when the vehicle is accelerating and deliver energy to the vehicle drive shaft.

17. The transmission of claim 16, wherein the accumulator apparatus comprises an accumulator hydraulic machine and the energy storage facility comprises a first tank of supply fluid and a second tank for holding pressurized fluid.

18. The transmission of claim 16, wherein the accumulator apparatus comprises an electric generator/motor and the energy storage facility comprises an electric storage battery.

19. The transmission of claim 2 further comprising:
a single planetary gear set having only:
a sun gear responsive to the input drive provided by the primary engine;
a planet carrier having planet idler gears for providing the output for the transmission; and
an outside ring gear meshing with the sun gear through the planet idler gears;
the ring gear being connected to the output gear of the orbital gear complex to provide a feedback torque to the control gear of the orbital gear complex that opposes the resistive torque of the rotary control device to decrease the rate of change in the ratio between the input drive provided by the primary engine and the output of the transmission from a highest reduction to the predetermined overdrive.

20. The transmission of claim 19, wherein:
when rotation of the planet carrier is prevented, the ring gear rotates in a direction opposite to the sun gear input drive;
when the planet carrier begins to rotate in the same direction as the sun gear input drive and then begins to increase speed, the opposite rotation of the ring gear decreases proportionally until the ring gear stops, and the planet carrier is rotating at a predetermined reduction of the sun gear input drive; and
when the ring gear begins to rotate in the same direction as the sun gear input drive and the rotation of the ring gear increases until it is equal to the rotation of the sun gear input drive, the planet carrier rotates 1:1 with the sun gear input drive.

21. The transmission of claim 20, wherein, when the planet carrier is rotating 1:1 with the sun gear input drive and the control gear of the orbital gear complex is still rotating, the ring gear rotation increases in speed beyond the speed of rotation of the sun gear input drive, the increase in speed of the ring gear being inversely proportional to the speed of the control gear until rotation of the control gear is prevented and the planet carrier is rotating at a predetermined overdrive of the input drive.

22. A transmission providing an output gear ratio for a primary engine, the transmission comprising:
an orbiter gear complex comprising only:
an input connecting the primary engine to an orbiter web, a control gear and an output gear, all mounted for rotation about a first axis, and
at least one cluster gear mounted for rotation on an orbit shaft positioned parallel with the first axis and supported on the orbiter web in mesh with only the control gear and the output gear to permit the orbit shaft and the cluster gear to orbit, respectively, the first axis and the control gear and output gear;
wherein a first gear tooth ratio between the cluster gear and the control gear and a second gear tooth ratio between the cluster gear and the output gear are selected such that:
when rotation of the control gear is prevented, rotation of the orbiter web produces rotation of the output gear at a predetermined overdrive of the input drive provided by the primary engine; and
when rotation of the output gear is prevented, rotation of the orbiter web produces rotation of the control gear at a predetermined reduction of the input drive provided by the primary engine; and
a control device for providing a resistance torque;
the control gear being responsive to the resistance torque provided by the control device, rotation of the control gear being slowed in proportion to the resistance torque provided by the control device.

23. The transmission of claim 22 further comprising:
a single planetary gear complex having only:
an input connecting the primary engine to a sun gear meshing with an outside ring gear through a set of planet idle gears mounted on a planet carrier that provides output for the transmission; and
the ring gear connecting with the output gear of the orbital gear complex and providing a feed-back torque to the control gear of the orbital gear complex opposing the resistance torque of the control device to decrease the rate of change in the output gear ratio of the transmission between a highest reduction and the predetermined overdrive of the input drive provided by the primary engine.

24. The transmission of claim 23, wherein the control device for providing a resistance torque is a hydraulic jack.

25. The transmission of claim 23, wherein:
the primary engine is an electric motor;
the control device for providing a resistance torque is an electric motor; and
when rotation of the control gear of the orbiter gear complex is prevented, rotation of the orbiter web produces rotation of the output gear at a predetermined reduction of the input drive provided by the primary engine.
